(19) United States
(12) Patent Application Publication
(10) Pub. No.: US 2026/0126685 A1
(43) Pub. Date: May 7, 2026

(54) DISPLAY DEVICE

(71) Applicant: Sharp Display Technology Corporation, Kameyama City (JP)

(72) Inventor: Hiroshi MATSUKIZONO, Kameyama City (JP)

(21) Appl. No.: 19/341,091

(22) Filed: Sep. 26, 2025

(30) Foreign Application Priority Data
Nov. 7, 2024 (JP) 2024-195107

(51) Int. Cl. G02F 1/1333; G06F 3/041

(52) U.S. Cl. CPC G02F 1/13338; G06F 3/0416

(57) ABSTRACT

A display device includes a first substrate having a display area and a non-display area, a first wire placed in the display area and composed of a first conducting film, a heating wire placed in the display area and composed of the first conducting film, a first connected portion placed in the non-display area, composed of the first conducting film, and connected to the heating wire, a second connected portion placed in the non-display area with the first connected portion between the second connected portion and the first wire and composed of the first conducting film, a first insulating film, and a third connected portion placed in the non-display area and composed of a second conducting film. The first insulating film is provided with a first contact hole overlapping the first wire and the third connected portion and a second contact hole overlapping the second and third connected portions.

### BACKGROUND

### 1. Field

The present disclosure relates to a display device that makes it hard for a heating wire and a first wire to become short-circuited with each other and that makes it hard for the heating wire to become markedly higher in temperature.

### 2. Description of the Related Art

Conventionally, as an example of a display device, a liquid crystal display device disclosed in U.S. Patent Application Publication No. 2004/0207588 has been known. The liquid crystal display device disclosed in U.S. Patent Application Publication No. 2004/0207588 includes a liquid crystal panel, a memory in which current data representing the present brightness of each pixel provided in the liquid crystal panel is stored until the next time, a look-up table having stored in advance therein (i) combinations of the previous data and the present data, inputtable combinations, and (ii) output signals corresponding separately to each of the combinations, a control unit that outputs an output signal as corrected present data to make it easy to make a shift in grayscale from the previous time to the present time, a heater that heats the liquid crystal panel, a heater control unit that controls the start and stoppage of heating by the heater so that the temperature of the liquid crystal panel falls within a range of ±3° C. from a predetermined target temperature falling within a range of 33° C. to 63° C.

In the liquid crystal display device disclosed in U.S. Patent Application Publication No. 2004/0207588, the heater is configured such that a heater electrode composed of a transparent electrode film and a metal electrode are connected to each other. Since there occurs contact resistance in a place of connection between the heater electrode and the metal electrode, the place of contact may become markedly higher in temperature due to the connection resistance. On the other hand, it has been difficult for the heater electrode and the metal electrode to be constituted by the same metal material, as there is concern that they may become short-circuited with other electrodes or wires provided in the liquid crystal panel.

It is desirable to make it hard for a heating wire and a first wire to become short-circuited with each other and make it hard for the heating wire to become markedly higher in temperature.

### SUMMARY

According to an aspect of the disclosure, there is provided a display device including a first substrate having a display area where an image is displayed and a non-display area where the image is not displayed, a first wire that is placed in the display area of the first substrate, that extends along a first direction, and that is composed of part of a first conducting film, a heating wire that is placed in the display area of the first substrate, that extends along the first direction, and that is composed of a portion of the first conducting film that is different from the first wire, a first connected portion that is placed in the non-display area of the first substrate, that extends along a second direction intersecting the first direction, that is composed of a portion of the first conducting film that is different from the first wire and the heating wire, and that is connected to the heating wire, a second connected portion that is placed in the non-display area of the first substrate with the first connected portion interposed between the second connected portion and the first wire and that is composed of a portion of the first conducting film that is different from the first wire, the heating wire, and the first connected portion, a first insulating film placed at a higher layer than the first conducting film, and a third connected portion that is placed in the non-display area of the first substrate, that is composed of part of a second conducting film placed at a higher layer than the first insulating film, and that passes transversely across the first connected portion and overlaps part of the first wire and part of the second connected portion. The first insulating film is provided with a first contact hole placed in such a position as to overlap both the first wire and the third connected portion and a second contact hole placed in such a position as to overlap both the second connected portion and the third connected portion.

### BRIEF DESCRIPTION OF THE DRAWINGS

FIG. 1 is a plan view of a liquid crystal panel, a flexible substrate, a control substrate, or other components of a liquid crystal display device according to Embodiment 1;

FIG. 2 is a cross-sectional view of the liquid crystal panel, the flexible substrate, the control substrate, or other components according to Embodiment 1;

FIG. 3 is a circuit diagram showing an electrical configuration of an array substrate constituting the liquid crystal panel according to Embodiment 1;

FIG. 4 is a plan view showing a configuration pertaining to a touch panel function and a configuration pertaining to a heater function of the array substrate according to Embodiment 1;

FIG. 5 is a cross-sectional view showing a configuration of a TFT of the array substrate according to Embodiment 1 and an area therearound;

FIG. 6 is a cross-sectional view showing a configuration of a central part of a pixel electrode of the array substrate according to Embodiment 1 in a Y-axis direction and an area therearound;

FIG. 7 is a cross-sectional view showing a place of connection between a touch electrode and a touch wire of the array substrate according to Embodiment 1;

FIG. 8 is a cross-sectional view showing a place of connection among a touch wire, a touch terminal area, and a bridge wire of the array substrate according to Embodiment 1;

FIG. 9 is a cross-sectional view showing a configuration of a TFT of an array substrate according to Embodiment 2 and an area therearound;

FIG. 10 is a cross-sectional view showing a configuration of a central part of a pixel electrode of the array substrate according to Embodiment 2 in a Y-axis direction and an area therearound; and

FIG. 11 is a cross-sectional view showing a place of connection between a touch electrode and a touch wire of the array substrate according to Embodiment 2.

### DESCRIPTION OF THE EMBODIMENTS

### Embodiment 1

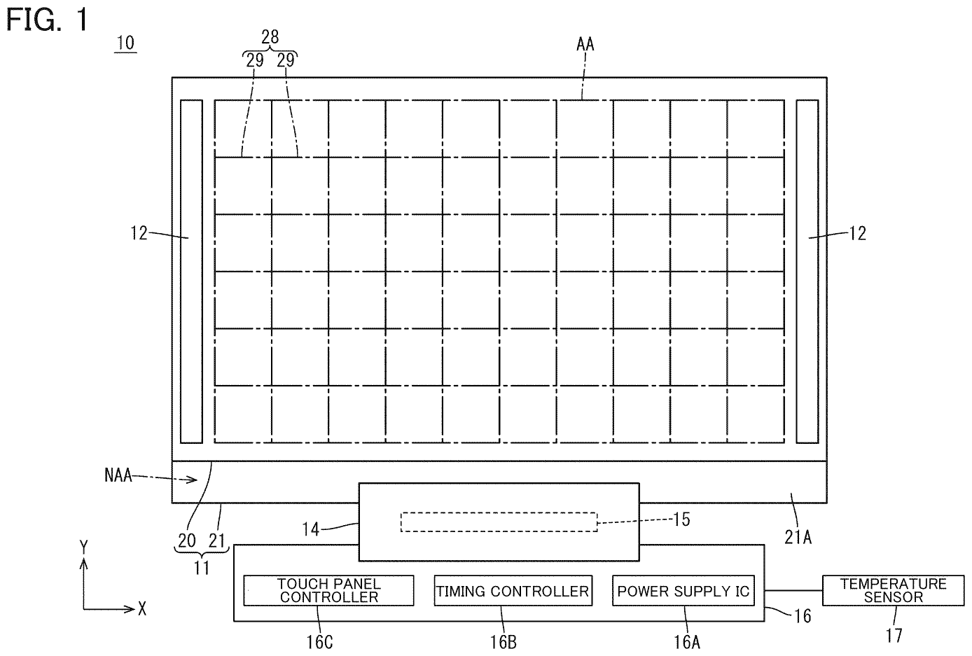

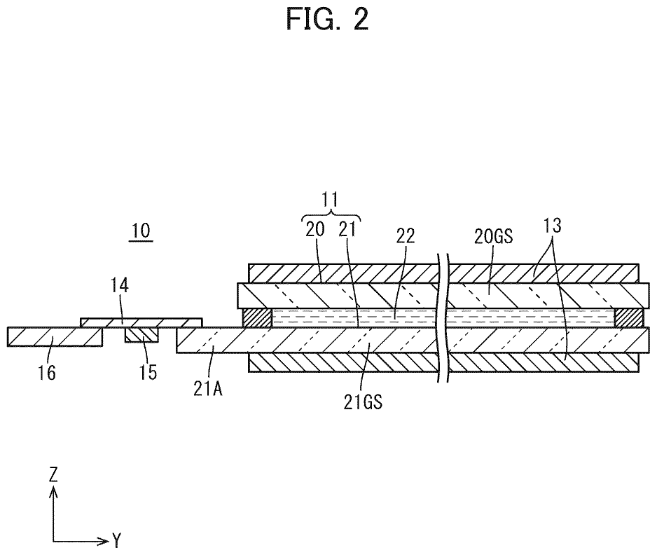

Embodiment 1 is described with reference to FIGS. 1 to 8. The present embodiment illustrates a liquid crystal display device 10 that is used in an on-board CMS (camera monitor system). The on-board CMS is a system that, as a replacement for a side mirror or a rearview mirror using a mirror-finished surface in an automobile, displays, on a display (liquid crystal display device 10), an image taken by a camera. The liquid crystal display device 10 according to the present embodiment has a display function and a touch panel function (position input function). Note that some of the drawings show an X axis, a Y axis, and a Z axis and are drawn so that the direction of each axis is an identical direction in each drawing. Further, FIGS. 2, 5 to 8 show front side up and back side down.

As shown in FIG. 1, the liquid crystal display device 10 includes at least a liquid crystal panel (display device, display panel) 11 that has a horizontally long rectangular shape and that is capable of displaying an image and a backlight device (lighting device) serving as an external light source that illuminates the liquid crystal panel 11 with light for use in display. The backlight device is placed at the back (behind) the liquid crystal panel 11 and includes a light source (e.g. an LED) that emits white light, an optical member that, by imparting an optical effect to light from the light source, converts the light into surface light, or other components. A central portion of a screen (principal surface) of the liquid crystal panel 11 serves as a display area AA where an image is displayed. On the other hand, a frame-shaped outer peripheral portion of the screen of the liquid crystal panel 11 that surrounds the display area AA serves as a non-display area NAA where the image is not displayed.

In the non-display area NAA of the liquid crystal panel 11, as shown in FIG. 1, a circuit unit (peripheral circuit unit, gate circuit unit) 12 is provided. A pair of the circuit units 12 are placed in such a manner that the display area AA is interposed therebetween in an X-axis direction. The circuit unit 12 is provided in a band-like area extending along a Y-axis direction. The circuit unit 12 is intended to supply a scanning signal to the after-mentioned gate wire 26 and is provided monolithically in the after-mentioned array substrate 21. The circuit unit 12 is a GDM (gate driver monolithic) circuit. The circuit unit 12 includes a shift register circuit that outputs a scanning signal at a predetermined timing, a buffer circuit for amplifying a scanning signal, or other circuits.

The liquid crystal panel 11 is described in detail with reference to FIG. 2 in addition to FIG. 1. As shown in FIGS. 1 and 2, the liquid crystal panel 11 includes a pair of substrates 20 and 21 bonded together. A front (frontward) one of the pair of substrates 20 and 21 is a counter substrate (second substrate) 20, and a back (backward) one of the pair of substrates 20 and 21 is an array substrate (first substrate) 21. The counter substrate 20 is obtained by forming a stack of various types of film on an inner surface of a glass substrate (substrate unit) 20GS, and the array substrate 21 is obtained by forming a stack of various types of film on an inner surface of a glass substrate (substrate unit) 21GS. Sandwiched between the pair of substrates 20 and 21 is a liquid crystal layer (medium layer) 22 containing liquid crystal molecules constituting a substance whose optical properties vary in the presence of the application of an electric field. Sandwiched between the outer edges of the pair of substrates 20 and 21 is a seal portion 23 that seals in the liquid crystal layer 22. The seal portion 23 is formed in a rectangular frame shape (endless annular shape) to surround the liquid crystal layer 22. Attached to outer surfaces of the two substrates 20 are polarizing plates 13, respectively.

As shown in FIGS. 1 and 2, the counter substrate 20 has short-side dimensions that are shorter than those of the array substrate 21. The counter substrate 20 is bonded to the array substrate 21 in such a manner that one end of the counter substrate 20 meets one end of the array substrate 21 in a short-side direction (Y-axis direction). Accordingly, the other end of the array substrate 21 in the short-side direction serves as an exposed portion 21A exposed by projecting laterally from the counter substrate 20. The exposed portion 21A is a side portion of the non-display area NAA, which has a frame shape, that extends along the X-axis direction, and is mounted with a flexible substrate 14 for supplying various types of signal.

The flexible substrate 14 is configured such that a large number of wiring patterns are formed on a base material composed of a synthetic resin material (such as polyimide resin) having insulating properties and flexibility. As shown in FIGS. 1 and 2, a driver 15 is mounted on the flexible substrate 14 by COF (Chip on Film). The driver 15 is composed of an LSI chip having a drive circuit inside. The driver 15 processes various types of signal that are transmitted by the flexible substrate 14. The driver 15 is intended to supply various types of signal (e.g. an image signal) to a wire (e.g. the after-mentioned source wire 27) of the display area AA. One end of the flexible substrate 14 is connected to the exposed portion 21A of the array substrate 21, and the other end of the flexible substrate 14 is connected to a control substrate 16. The flexible substrate 14 is connected to a central portion of the exposed portion 21A in the X-axis direction. The control substrate 16 is configured such that a plurality of circuit components are mounted on a rigid substrate made of synthetic resin (e.g. made of paper phenol or made of glass epoxy). The plurality of circuit components include a power supply IC (integrated circuit) 16A serving as a direct-current power supply for outputting electric power, a timing controller 16B that generates various types of signal to be supplied to the driver 15, a touch panel controller 16C that controls the touch panel function, a level shifter IC for controlling (stepping down and stepping up) a voltage level, or other components. The control substrate 16 has a connector area to which the flexible substrate 14 or other components are connected. The control substrate 16 is disposed to overlap the back of the backlight device by the flexible substrate 14 being bent in a turnover shape. Connected to the control substrate 16 is a temperature sensor 17. The temperature sensor 17 is placed in such a position as to be close to or in contact with the liquid crystal panel 11, and is enabled to detect the temperature of an area around the liquid crystal panel 11.

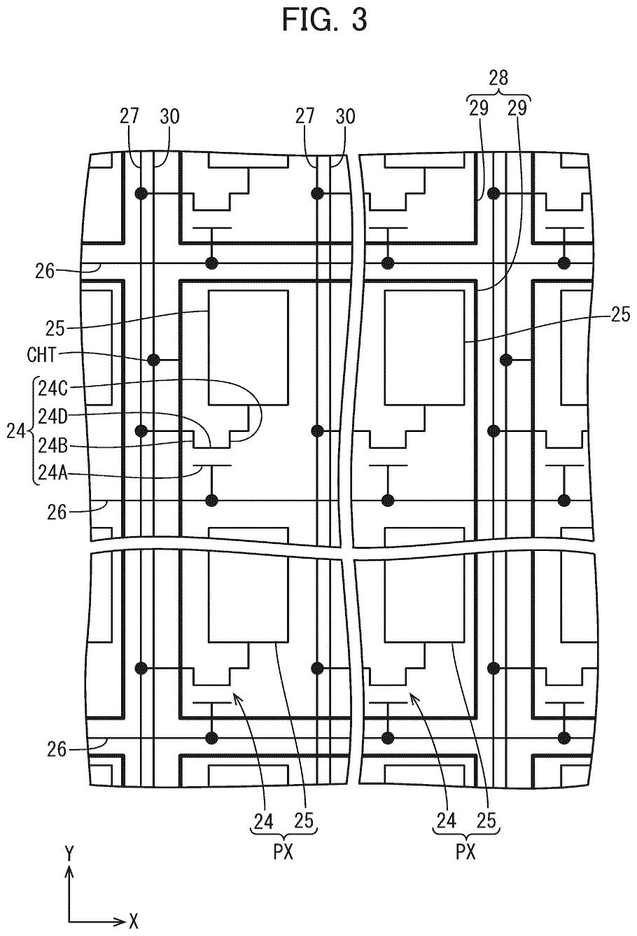

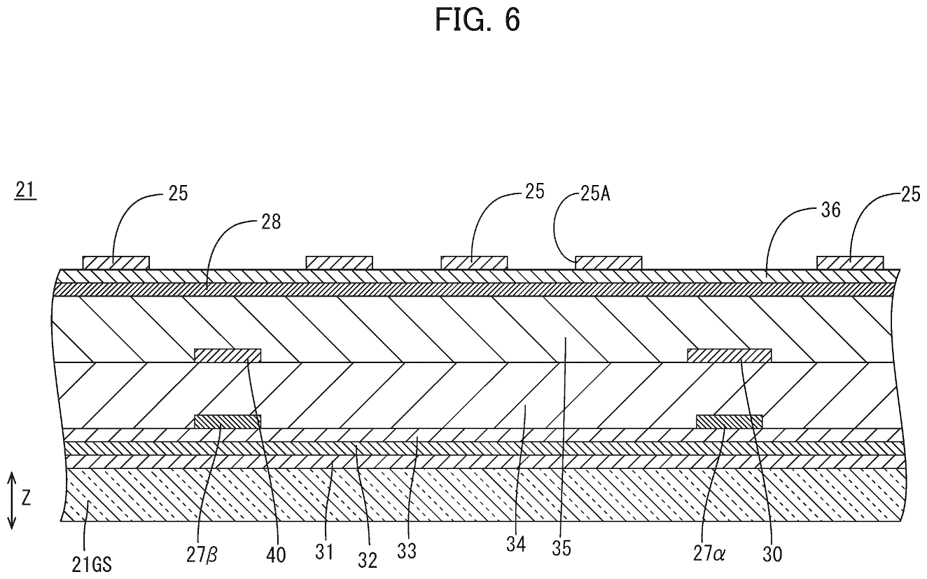

Next, a configuration of the array substrate 21 in the display area AA is described with reference to FIG. 3. As shown in FIG. 3, at least a TFT (switching element, transistor) 24 and a pixel electrode 25 are provided at the side of an inner surface of the array substrate 21 in the display area AA. The TFT 24 and the pixel electrode 25 constitute a pixel PX serving as a display unit together with the after-mentioned color filter. A plurality of the TFTs 24 and a plurality of the pixel electrodes 25 are provided in a matrix (rows and columns) by being arranged at spacings along the X-axis direction and the Y-axis direction. Arranged around this TFT 24 and this pixel electrode 25 are a gate wire (scanning wire) 26 and a source wire (image wire, signal wire) 27 that are orthogonal to (intersect) each other. The gate wire 26 extends along the X-axis direction, and includes a plurality of the gate wires 26 placed at spacings in the Y-axis direction. The source wire 27 extends along the Y-axis direction (first direction), and includes a plurality of the source wires 27 placed at spacings in the X-axis direction (second direction intersecting the first direction). The TFT 24 includes a gate electrode 24A connected to the gate wire 26, a source electrode 24B connected to the source wire 27, a drain electrode 24C connected to the pixel electrode 25, and a semiconductor component 24D connected to the source electrode 24B and the drain electrode 24C. Moreover, the TFT 24 is driven in accordance with a scanning signal supplied from the circuit unit 12 to the gate electrode 24A through the gate wire 26. Then, a potential pertaining to an image signal supplied from the driver 15 to the source electrode 24B through the source wire 27 is supplied to the drain electrode 24C via the semiconductor component 24D. As a result of that, the pixel electrode 25 is charged to the potential pertaining to the image signal. The pixel electrode 25 is placed in an area surrounded by the gate wire 26 and the source wire 27, and is substantially rectangular in planar shape. Further, at the side of the inner surface of the array substrate 21 in the display area AA, a common electrode 28 is formed in such a manner as to overlap all pixel electrodes 25 (see FIG. 6). The common electrode 28 extends substantially all over the display area AA.

Further, a plurality of color filters are provided in such a position on the counter substrate 20 in the display area AA as to be opposite to each pixel electrode 25 of the array substrate 21. The color filters are placed such that three colors of R (red), green (G), and B (blue) are repeatedly arranged in a predetermined order, and constitute pixels PX (red, green, and blue pixels) of each separate color together with the TFT 24 and the pixel electrode 25. The three pixels PX, namely the red, green, and blue pixels, constitute a display pixel that is capable of a color display of a predetermined tone. Further, a light shield (black matrix) for avoiding a mixture of colors is formed between one color filter and another. Provided on the innermost surfaces of the counter substrate 20 and the array substrate 21 are alignment films for aligning the liquid crystal molecules contained in the liquid crystal layer 22, respectively.

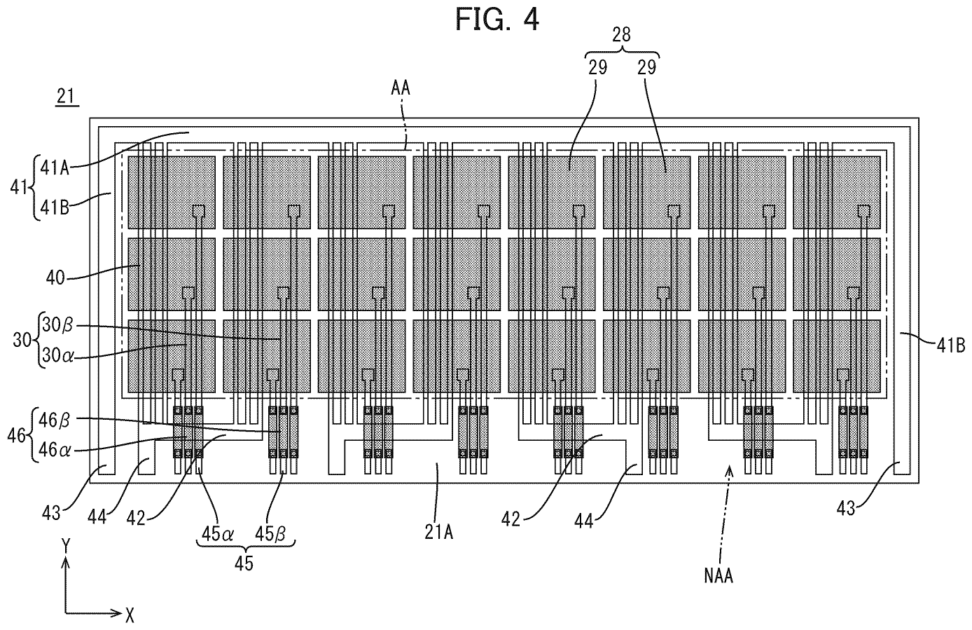

The liquid crystal panel 11 according to the present embodiment has a combination of the display function of displaying an image and the touch panel function of detecting a position (input position) that a user inputs on the basis of an image being displayed, and has integrated therewith (in an in-cell manner) a touch panel pattern for fulfilling the touch panel function. A configuration pertaining to the touch panel function is described with reference to FIG. 4. FIG. 4 illustrates, by half-tone dot meshing, components (i.e. the after-mentioned touch electrode 29 and the after-mentioned bridge wire 46) composed of the after-mentioned first transparent electrode film. The touch panel pattern for fulfilling the touch panel function is of a so-called projected capacitive type, and adopts a self-capacitive detecting scheme. As shown in FIG. 4, the touch panel pattern is constituted by a plurality of touch electrodes (first electrodes, position detecting electrodes) 29 placed side by side in a matrix in the principal surface of the liquid crystal panel 11. The touch electrodes 29 are placed in the display area AA of the liquid crystal panel 11. Accordingly, the display area AA of the liquid crystal panel 11 substantially coincides with a touch area (position input area) that is capable of detecting an input position, and the non-display area NAA substantially coincides with a non-touch area (non-position input area) that is incapable of detecting an input position. The touch electrodes 29 are constituted by the common electrode 28 described above. The common electrode 28 has a partition slit that partitions adjacent touch electrodes 29 from each other. This partition slit causes the common electrode 28 to constitute the plurality of touch electrodes 29, which are divided in a gridiron manner and which are electrically independent of each other. Moreover, when the user moves his/her finger (position input body) as an electric conductor toward a surface of the liquid crystal panel 11 in an attempt to do position input on the basis of an image that he/she views in the display area AA of the liquid crystal panel 11, capacitances are formed between the finger and touch electrodes 29. As a result, a capacitance that is detected by a touch electrode 29 located near the finger changes as the finger approaches, and becomes different from that which is detected by a touch electrode 29 located away from the finger, whereby it becomes possible to detect the input position. The specific number of touch electrodes 29 that are provided are subject to appropriate change other than that illustrated in FIG. 4. Each of the touch electrodes 29 has a substantially square shape when seen in plan view, and has a dimension of approximately several millimeters on a side. Accordingly, each of the touch electrodes 29 is much larger in plan-view size than the pixel PX, and is disposed in an area covering a plurality of the pixels PX in the X-axis direction and the Y-axis direction.

At the side of the inner surface of the array substrate 21 in the display area AA, as shown in FIG. 4, a plurality of touch wires (first wires, position detecting wires) 30 connected to the plurality of touch electrodes 29 are provided. The touch wires 30 extend along the Y-axis direction and run parallel to the source wire 27. A plurality of the touch wires 30 are placed at spacings in the X-axis direction. A plurality of the touch wires 30 connected to a plurality of the touch electrodes 29 arranged along the Y-axis direction to form one line are unevenly distributed on one side (i.e. the right side of FIG. 4) of the plurality of touch electrodes 29 forming the line in the X-axis direction. The touch wires 30 are configured such that a common potential signal (reference potential signal) pertaining to the display function and touch signals (position detection signals) pertaining to the touch panel function are supplied from the touch panel controller 16C to the touch wires 30 at different timings (in a time-division manner) (see FIG. 1). The touch panel controller 16C supplies the common potential signal to the touch wires 30 in synchronization with a timing at which signals pertaining to the display function are supplied from the timing controller 16B to the driver 15. The timing during which the common potential signal is supplied from the touch panel controller 16C to the touch wires 30 is a display period, and the timing during which the touch signals are supplied from the touch panel controller 16C to the touch wires 30 is a sensing period (position detection period). During the display period, all touch electrodes 29 are brought to a common potential (reference potential) to function as the common electrode 28, as the common potential signal is supplied to all touch wires 30.

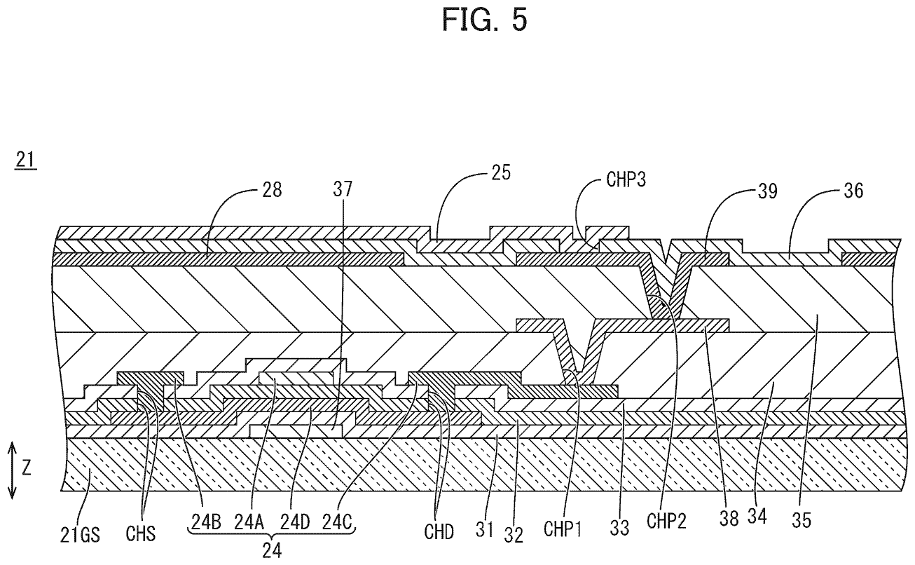

Various types of film stacked at the side of the inner surface of the array substrate 21 are described here with reference to FIG. 5. FIG. 5 is a cross-sectional view showing a configuration of a TFT 24 of the array substrate 21 and an area therearound. On the glass substrate (substrate) 21GS of the array substrate 21, as shown in FIG. 5, at least a first metal film, a basecoat film 31, a semiconductor film, a gate insulating film 32, a second metal film, a first interlayer insulating film (fourth insulating film) 33, a third metal film (fourth conducting film), a first planarizing film (third insulating film) 34, a fourth metal film (first conducting film), a second planarizing film (first insulating film) 35, a first transparent electrode film (second conducting film), a second interlayer insulating film (second insulating film) 36, a second transparent electrode film (third conducting film), an alignment film (not illustrated) are stacked in this order from a lower layer side (glass substrate 21GS side).

The first metal film, the second metal film, the third metal film, and the fourth metal film each have electric conductivity by being a single-layer film composed of one type of metal material or a laminated film or alloy composed of different types of metal material. The first metal film constitutes the after-mentioned light shield 37. The second metal film constitutes the gate wire 26, the gate electrode 24A of the TFT 24, or other components. The third metal film constitutes the source wire 27, the source electrode 24B and drain electrode 24C of the TFT 24, or other components. The fourth metal film constitutes the touch wires 30 or other components. The fourth metal film is, for example, a laminated film and may include, at the uppermost layer, a layer composed of Ti (titanium) or Mo (molybdenum). The semiconductor film is composed of a polysilicon semiconductor material (semiconductor material) having a crystalline substance prepared by a publicly-known method such as laser crystallization. The polysilicon semiconductor material of the semiconductor film is high in electron mobility than an amorphous silicon semiconductor material and an oxide semiconductor material. The semiconductor film constitutes the semiconductor component 24D of the TFT 24 or other components. The first transparent electrode film and the second transparent electrode film are made of a transparent electrode material (e.g. ITO (indium tin oxide) or IZO (indium zinc oxide)). The first transparent electrode film constitutes the common electrode 28 (touch electrodes 29) or other components. The second transparent electrode film constitutes the pixel electrode 25 or other components.

The basecoat film 31, the gate insulating film 32, the first interlayer insulating film 33, and the second interlayer insulating film 36 are each composed of SiO₂ (oxide silicon, Si oxide), SiNₓ (silicon nitride), or other inorganic materials (inorganic resin material). The first planarizing film 34 and the second planarizing film 35 are composed of an organic material such as PMMA (acrylic resin). The film thicknesses of the first planarizing film 34 and the second planarizing film 35 are usually greater than the film thicknesses of the basecoat film 31, the gate insulating film 32, the first interlayer insulating film 33, and the second interlayer insulating film 36. Specifically, while the film thicknesses of the basecoat film 31, the gate insulating film 32, the first interlayer insulating film 33, and the second interlayer insulating film 36, which are composed of an inorganic material, are, for example, approximately several tens of millimeters to several hundreds of millimeters, the film thicknesses of the first planarizing film 34 and the second planarizing film 35, which are composed of an organic material, are, for example, approximately 1 μm to 3 μm. An inner surface of the array substrate 21 (that faces the liquid crystal layer 22) is planarized by the first planarizing film 34 and the second planarizing film 35. The basecoat layer 31 is sandwiched between the semiconductor film and the first metal film. The gate insulating film 32 is sandwiched between the semiconductor film and the second metal film. The first interlayer insulating film 33 is sandwiched between the second metal film and the third metal film. The first planarizing film 34 is sandwiched between the third metal film and the fourth metal film. The second planarizing film 35 is sandwiched between the fourth metal film and the first transparent electrode film. The second interlayer insulating film 36 is sandwiched between the first transparent electrode film and the second transparent electrode film.

A cross-sectional configuration of the TFT 24 is described. As shown in FIG. 5, the TFT 24 according to the present embodiment is of a so-called top-gate type in which the gate electrode 24A, which is composed of part of the second metal film, is disposed at a higher layer than the semiconductor component 24D, which is composed of part of the semiconductor film, to overlap the semiconductor component 24D via the gate insulating film 32. While both end portions of the semiconductor component 24D that do not overlap the gate electrode 24A are resistance-decreased regions made low in resistance, a central portion of the semiconductor component 24D that overlaps the gate electrode 24A is a non-resistance-decreased region that is not made low in resistance. The resistance-decreased regions of the semiconductor component 24D are formed by performing a resistance-decreasing process with the gate electrode 24A as a mask, for example, in the process of manufacturing the array substrate 21. The array substrate 21 is provided with a light shield 37 that overlaps at least the non-resistance-decreased region of the semiconductor component 24D. The light shield 37 is composed of part of the first metal film. The light shield 37, which is placed at a lower layer than the non-resistance-decreased region of the semiconductor component 24D, can block light that is shone on the non-resistance-decreased region of the semiconductor component 24D from the backlight device. This makes it possible to reduce fluctuations in the characteristics of the TFT 24 that can occur in a case where the non-resistance-decreased region of the semiconductor component 24D is irradiated with light.

As shown in FIG. 5, the source electrode 24B of the TFT 24 is composed of part of the third metal film, and is disposed to overlap one resistance-decreased region (one end portion) of the semiconductor component 24D via the gate insulating film 32 and the first interlayer insulating film 33. The gate insulating film 32 and the first interlayer insulating film 33 have a source contact hole (fourth contact hole) CHS bored through portions of the gate insulating film 32 and the first interlayer insulating film 33 that overlap both the source electrode 24B and the semiconductor component 24D. The source electrode 24B and the semiconductor component 24D are connected to each other through the source contact hole CHS. The drain electrode 24C of the TFT 24 is composed of part of the third metal film, and is disposed to overlap the other resistance-decreased region (other end portion) of the semiconductor component 24D via the gate insulating film 32 and the first interlayer insulating film 33. The gate insulating film 32 and the first interlayer insulating film 33 have a drain contact hole (fifth contact hole) CHD bored through portions of the gate insulating film 32 and the first interlayer insulating film 33 that overlap both the drain electrode 24C and the semiconductor component 24D. The drain electrode 24C and the semiconductor component 24D are connected to each other through the drain contact hole CHD.

As shown in FIG. 5, the TFT 24 includes a first intermediate electrode (fourth connected portion) 38 and a second intermediate electrode (fifth connected portion) 39 that are located in between the drain electrode 24C, which is composed of part of the third metal film, and the pixel electrode 25, which is composed of part of the second transparent electrode film. The first intermediate electrode 38 is composed of part of the fourth metal film (i.e. a portion of the fourth metal film that is different from the touch wires 30 and a heating wire 40). The first intermediate electrode 38 is disposed at a higher layer than part of the drain electrode 24C (i.e. a portion of the drain electrode 24C that does not overlap the semiconductor component 24D) to overlap the part of the drain electrode 24C via the first planarizing film 34. The second intermediate electrode 39 is composed of part of the first transparent electrode film (i.e. a portion of the first transparent electrode film that is different from the common electrode 28 and the touch electrodes 29). The second intermediate electrode 39 is disposed at a higher layer than part of the first intermediate electrode 38 (i.e. a portion of the first intermediate electrode 28 that does not overlap the drain electrode 24C) to overlap the part of the first intermediate electrode 38 via the second planarizing film 35. The second intermediate electrode 39 is placed at a lower layer than part of the pixel electrode 25 to overlap the part of the pixel electrode 25 via the second interlayer insulating film 36. The first planarizing film 34, which is sandwiched between the drain electrode 24C and the first intermediate electrode 38, has a first pixel contact hole (sixth contact hole) CHP1 bored in a portion of the first planarizing film 34 that overlaps both the drain electrode 24C and the first intermediate electrode 38. The drain electrode 24C and the first intermediate electrode 38 are connected to each other through the first pixel contact hole CHP1 of the first planarizing film 34. The second planarizing film 35, which is sandwiched between the first intermediate electrode 38 and the second intermediate electrode 39, has a second pixel contact hole (seventh contact hole) CHP2 bored in a portion of the second planarizing film 35 that overlaps both first intermediate electrode 38 and the second intermediate electrode 39. The first intermediate electrode 38 and the second intermediate electrode 39 are connected to each other through the second pixel contact hole CHP2 of the second planarizing film 35. The second interlayer insulating film 36, which is sandwiched between the second intermediate electrode 39 and the pixel electrode 25, has a third pixel contact hole (eighth contact hole) CHP3 bored in a portion of the second interlayer insulating film 36 that overlaps both the second intermediate electrode 39 and the pixel electrode 25. The second intermediate electrode 39 and the pixel electrode 25 are connected to each other through the third pixel contact hole CHP3 of the second interlayer insulating film 36. In this way, the drain electrode 24C is connected to the pixel electrode 25 via the first intermediate electrode 38 and the second intermediate electrode 39.

Further, as shown in FIG. 6, the common electrode 28 of the array substrate 21 in the display area AA is disposed to overlap all pixel electrodes 25. FIG. 6 shows a cross-sectional configuration of a central part of a pixel electrode 25 of the array substrate 21 in the Y-axis direction and an area therearound. The common electrode 28 extends substantially all over the display area AA. The common electrode 28, which is composed of part of the first transparent electrode film, is placed at a lower layer (i.e. closer to the glass substrate 21GS) than the pixel electrode 25, which is composed of part of the second transparent electrode film, with a distance equal to the film thickness of the second interlayer insulating film 36 between the common electrode 28 and the pixel electrode 25. The common electrode 28 is supplied with a common potential signal that is at a common electrode (reference potential). The pixel electrode 25, which is located at a higher layer than the common electrode 28, has a slit 25A bored therein. When driving of the TFT 24 causes the pixel electrode 25 to be charged to a potential based on an image signal transmitted to the source wire 27, a potential difference is generated between the pixel electrode 25 and the common electrode 28. Then, a fringe field (oblique field) containing a component normal to a principal surface of the array substrate 21 in addition to a component parallel to the principal surface of the array substrate 21 is generated between an opening edge of the slit 25A and the common electrode 28. Accordingly, this fringe field can be utilized to control a state of alignment of the liquid crystal molecules contained in the liquid crystal layer 22, and a predetermined display is done on the basis of this state of alignment of the liquid crystal molecules. That is, the liquid crystal panel 11 according to the present embodiment operates in an FFS mode (fringe field switching) mode.

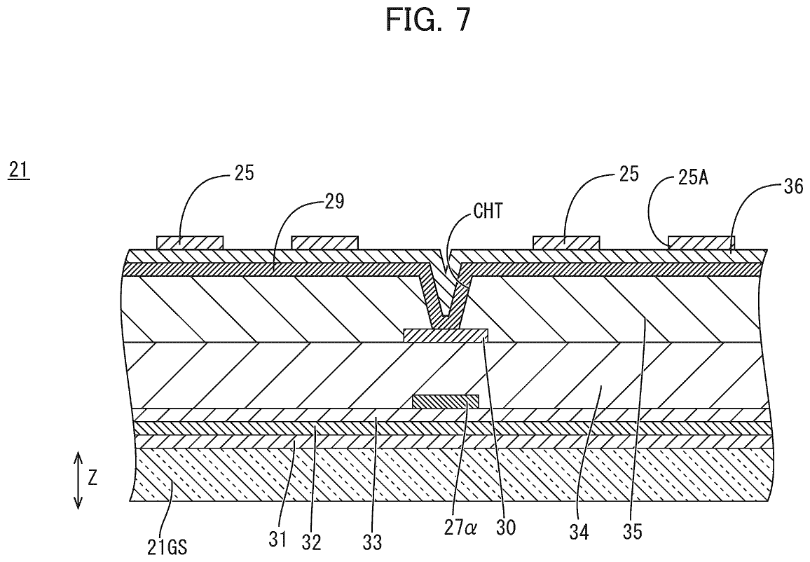

A connection structure between a touch electrode 29 formed by dividing the common electrode 28 and a touch wire 30 is described with reference to FIG. 7. As shown in FIG. 7, part of the touch wire 30, which is composed of the fourth metal film, is disposed at a lower layer than part of the touch electrode 29, which is composed of the first transparent electrode film, to overlap the part of the touch electrode 29 via the second planarizing layer 35. The second planarizing film 35 has a touch contact hole (third contact hole) CHT bored in a portion of the second planarizing film 35 that overlaps both the touch wire 30 and the touch electrode 29. The touch wire 30 and the touch electrode 29 are connected to each other via the touch contact hole CHT of the second planarizing film 35.

Incidentally, since the liquid crystal display device 10 according to the present disclosure is used in an on-board CMS, there tends to be strong concern that there may be a decrease in the response speed of the liquid crystal panel 11 due to an increase in the viscosity of the liquid crystal layer 22 in a cool environment. To address this problem, the liquid crystal panel 11 according to the present embodiment has a heater function for improving the response speed at low temperature, and has an in-cell configuration for fulfilling the heater function. The configuration pertaining to the heater function is described with reference to FIG. 4 or other drawings.

As shown in FIG. 4, the array substrate 21 includes, as the configuration pertaining to the heater function, a heating wire 40, a first trunk wire 41, a second trunk wire 42 (first connected portion), and a first heating terminal area 43, and a second heating terminal area 44. The heating wire 40, the first trunk wire 41, the second trunk wire 42, the first heating terminal area 43, and the second heating terminal area 44 are each composed of part of the fourth metal film. The heating wire 40 is placed in the display area AA, extends along the Y-axis direction, and runs parallel to the source wire 27 and the touch wire 30. The heating wire 40 longitudinally traverses the display area AA, and extends from the exposed portion 21A of the array substrate 21A to the opposite side of the array substrate 21 in the Y-axis direction. Accordingly, the heating wire 40 longitudinally traverses all of a plurality of the touch electrodes 29 arranged along the Y-axis direction in the display area AA to form one line. A plurality of the heating wires 40 are placed at spacings in the X-axis direction. A plurality of the heating wires 40 connected to a plurality of the touch electrodes 29 arranged along the Y-axis direction to form one line are unevenly distributed on another side (i.e. the left side of FIG. 4) of the plurality of touch electrodes 29 forming the line in the X-axis direction. Although the heating wire 40 is disposed to overlap the touch electrode 29, the heating wire 40 is not connected to the touch electrode 29 that the heating wire 40 overlaps. The second planarizing film 35, which is sandwiched between the heating wire 40, which is composed of part of the fourth metal film, and the touch electrode 29, which is composed of the first transparent electrode film, keeps the heating wire 40 and the touch electrode 29 insulated from each other (see FIG. 6). Thus, since the touch electrode 29 is also disposed to overlap at least part of the heating wire 40, to which the touch electrode 29 is not connected, the range of formation of the touch electrode 29 is sufficiently secured.

As shown in FIG. 4, the first trunk wire 41 and the second trunk wire 42 are both placed in the non-display area NAA. Specifically, the first trunk wire 41 extends along three sides of the non-display area NAA, which has a frame shape, except the exposed portion 21A, and surrounds the display area AA on three sides. The first trunk wire 41 has a first trunk wire constituting portion 41A placed on a side of the non-display area NAA that faces away from the exposed portion 21A in the Y-axis direction and a pair of second trunk wire constituting portions 41B placed on a pair of sides of the non-display area NAA located at both ends of the non-display area NAA in the X-axis direction. The first trunk wire constituting portion 41A extends along the X-axis direction, and is adjacent to the entire length of a side of the display area AA, which has a rectangular shape, that faces away from the exposed portion 21A in the Y-axis direction. The first trunk wire constituting portion 41A is joined to first ends (on the upper side of FIG. 4; on the side that faces away from the exposed portion 21A) of all heating wires 40, which are placed in the display area AA, in the Y-axis direction. The pair of second trunk wire constituting portions 41B extend along the Y-axis direction, and are adjacent to the entire lengths of both sides of the display area AA, which has a rectangular shape, that extend along the Y-axis direction, respectively. Ends of the second trunk wire constituting portions 41B that face the exposed portion 21A are connected to the after-mentioned first heating terminal area 43.

As shown in FIG. 4, the second trunk wire 42 is placed in the exposed portion 21A of the non-display area NAA, which has a frame shape. The second trunk wire 42 extends along the X-axis direction in the exposed portion 21A, and includes a plurality of the second trunk wires 42 placed at spacings in the X-axis direction. The plurality of second trunk wires 42 are placed in a linear arrangement. The number of second trunk wires 42 that are provided is half (in FIG. 4, four) of the total number (in FIG. 4, eight) of lines of touch electrodes 29 arranged along the X-axis direction. The second trunk wire 42 is joined to second ends (on the lower side of FIG. 4; beside the exposed portion 21A) of the plurality of heating wires 40, which are placed in the display area AA, in the Y-axis direction. Specifically, one second trunk wire 42 is joined to a plurality of (in FIG. 4, six) heating wires 40 that overlap touch electrodes 29 forming two lines arranged in a row along the X-axis direction. One group of touch wires 30 connected to touch electrodes 29 forming one line is interposed between two groups of heating wires 40 connected to one second trunk wire 42. The plurality of touch wires 30 include a group of touch wires 30 dimensionally interposed between two second trunk wires 42 in the X-axis direction.

As shown in FIG. 4, the first heating terminal area 43 and the second heating terminal area 44 are both provided in the exposed portion 21A of the array substrate 21. Specifically, the first heating terminal area 43 and the second heating terminal area 44 are both placed in such positions in the exposed portion 21A as to overlap the flexible substrate 14, and are connected via an anisotropic conductive film (ACF) to a plurality of terminal areas of the flexible substrate 14.

As shown in FIG. 4, two first heating terminal areas 43 are placed at a distance from each other in the X-axis direction in the exposed portion 21A. The two first heating terminal areas 43 are joined to ends (on the lower side of FIG. 4; beside the exposed portion 21A) of the two second trunk wire constituting portions 41B of the first trunk wire 41 that face away from the first trunk wire constituting portion 41A in the Y-axis direction, respectively. The two first heating terminal areas 43 are connected to positive electrode terminal areas included in the terminal areas of the flexible substrate 14 and connected to a positive electrode of the power supply IC (direct-current power supply) 16A, respectively. A plurality of the second heating terminal areas 44 are placed at spacings in the X-axis direction in the exposed portion 21A. The number of second heating terminal areas 44 that are provided is equal to the number of second trunk wires 42 that are provided. The plurality of second heating terminal areas 44 are connected separately to each of the plurality of second trunk wires 42. The second heating terminal areas 44 are joined to ends of the second trunk wires 42 at an end of the array substrate 21 in the X-axis direction. The plurality of second heating terminal areas 44 are connected to negative electrode terminal areas included in the terminal areas of the flexible substrate 14 and connected to a negative electrode of the power supply IC 16A, respectively.

As shown in FIG. 1, the array substrate 21 of the liquid crystal panel 11 configured as noted above is supplied with various types of signal (including image signals) for displaying an image, various types of signal (including touch signals) for fulfilling the touch panel function, and electric power for fulfilling the heater function from the control substrate 16 via the flexible substrate 14. Specifically, the circuit unit 12 of the array substrate 21 is supplied with gate start pulse signals, clock signals, or other signals from the control substrate 16 via the flexible substrate 14. The circuit unit 12 outputs scanning signals to the plurality of gate wires 26 in sequence in accordance with the gate start pulse signals, the clock signals, or other signals thus supplied. The plurality of source wires 27 of the array substrate 21 are supplied with image signals from the driver 15 via the flexible substrate 14. By being driven at timings at which the scanning signals are supplied to the gate wires 26, the TFTs 24 can charge the pixel electrodes 25 to potentials based on the image signals supplied to the source wires 27. As already described, the plurality of touch wires 30 of the array substrate 21 are supplied with touch signals and a common potential signal in a time-division manner from the touch panel controller 16C via the flexible substrate 14.

As shown in FIGS. 1 and 4, the positive electrode of the power supply IC 16A of the control substrate 16 is connected to the first heating terminal area 43 of the array substrate 21 via the flexible substrate 14, and the negative electrode of the power supply IC 16A of the control substrate 16 is connected to the second heating terminal area 44 via the flexible substrate 14. As a result of this, based on a potential difference between the first trunk wire 41, which is connected to the first heating terminal area 43, and the second trunk wire 42, which is connected to the second heating terminal area 44, a current flows through a plurality of the heating wires 40 from the first trunk wire 41 toward the second trunk wire 42. As the plurality of heating wires 40 are energized, heat corresponding to the respective wiring resistances of the plurality of heating wires 40 is generated from the plurality of heating wires 40. The heat generated from the plurality of heating wires 40, which are placed in the display area AA, is transferred to the liquid crystal layer 22, whereby the liquid crystal layer 22 is heated in the display area AA. Accordingly, even in a cool environment, the liquid crystal layer 22 is heated by the heat from the plurality of heating wires 40, whereby the viscosity of the liquid crystal layer 22 in the display area AA can be decreased. This makes it possible to improve the response speed of the liquid crystal panel 11 and improve the display quality of an image. The amount of current that is passed through the plurality of heating wires 40 from the power supply IC 16A or other quantities are controlled in accordance with the temperature detected by the temperature sensor 17.

As shown in FIG. 6, the heating wire 40 and the touch wire 30 are disposed to overlap different source wires 27 in a plan view. Specifically, the heating wire 40 and the touch wire 30 are composed of parts of the fourth metal film, and are disposed at a higher layer than the source wires 27, which are composed of part of the third metal film, to overlap the source wires 27 via the first planarizing film 34. In a case where a distinction between the plurality of source wires 27 is made, the source wire 27 overlapping the touch wire 30 in a plan view is referred to as “first source wire” with the suffix “α” added to its reference sign, and the source wire 27 overlapping the heating wire 40 in a plan view is referred to as “second source wire” with the suffix “β” added to its reference sign. In a case where no distinction is made, the suffixes are not added to the reference signs.

Thus, since the touch wire 30 and the heating wire 40 are disposed to overlap the first source wire 27α and the second source wire 27β via the first planarizing film 34, the aperture ratio of each pixel PX can be kept high while a short circuit is avoided. Moreover, since the heating wire 40 is composed of a portion of the fourth metal film that is different from the touch wire 30, the number of metal films can be made smaller than it is in a case where a metal film that constitutes the heating wire 40 is added. This makes it possible to reduce the number of processes for manufacturing the liquid crystal panel 11.

As shown in FIG. 4, an end (on the lower side of FIG. 4; beside the exposed portion 21A) of the touch wire 30, which is placed in the display area AA, that faces away from the touch electrode 29, to which the touch wire 30 is connected, in the Y-axis direction is drawn out to the non-display area NAA. On the other hand, the exposed portion 21A of the array substrate 21 is provided with a touch terminal area (second connected portion) 45 that is connected to the touch wire 30. As is the case with the touch wire 30, the heating wire 40, or other components, the touch terminal area 45 is composed of part of the fourth metal film. The touch terminal area 45 is provided in the exposed portion 21A of the array substrate 21. Specifically, a plurality of the touch terminal areas 45 are placed at spacings in the X-axis direction in the exposed portion 21A. The number of touch terminal areas 45 that are provided is equal to the number of touch wires 30 that are provided. The touch terminal area 45 is placed at a distance from the touch wire 30, to which the touch terminal area 45 is connected, in the Y-axis direction. The touch terminal area 45 is placed at a distance from the second heating terminal area 44 in the X-axis direction in the exposed portion 21A. As is the case with the first heating terminal area 43 and the second heating terminal area 44, the touch terminal area 45 is placed in such a position in the exposed portion 21A as to overlap the flexible substrate 14, and is connected via the anisotropic conductive film to a terminal area of the flexible substrate 14. A source terminal area (not illustrated) that is connected to an end of a source wire 27 is also placed in such a position in the exposed portion 21A as to overlap the flexible substrate 14, and is connected via the anisotropic conductive film to a terminal area of the flexible substrate 14.

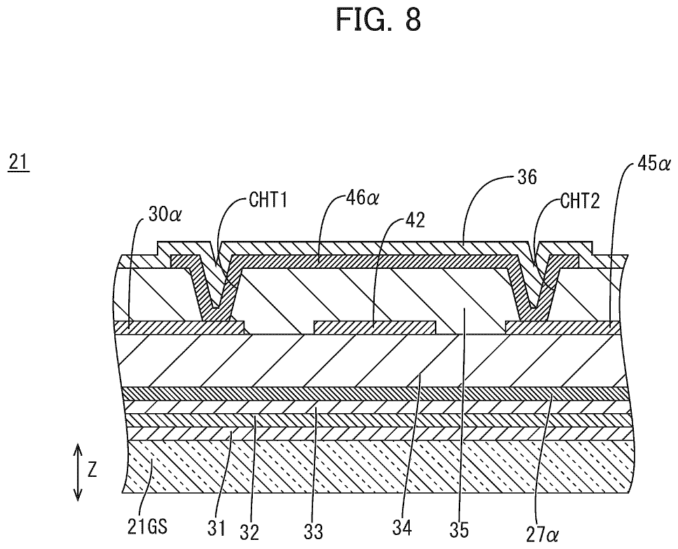

As shown in FIG. 4, the non-display area NAA of the array substrate 21 is provided with a bridge wire (third connected portion) for connecting the touch wire 30 and the touch terminal area 45. The bridge wire 46 overlaps an end (on the lower side of FIG. 4) of the touch wire 30 that faces away from the touch electrode 29, to which the touch wire 30 is connected, in the Y-axis direction and an end (on the upper side of FIG. 4) of the touch terminal area 45 that faces the touch wire 30, to which the touch terminal area 45 is connected, and extends across both of these ends. The bridge wire 46 is composed of the same part of the first transparent electrode film as the common electrode 28 (touch electrodes 29) and the second intermediate electrode 39. Accordingly, as shown in FIG. 8, the second planarizing film 35 is sandwiched between the bridge wire 46 and the touch wire 30 and between the bridge wire 46 and the touch terminal area 45. The second planarizing film 35 has a first bridge contact hole (first contact hole) CHB1 bored in a portion of the second planarizing film 35 that overlaps both the touch wire 30 and the bridge wire 46. The e touch wire 30 and the bridge wire 46 are connected to each other through the first bridge contact hole CHB1 of the second planarizing film 35. The second planarizing film 35 has a second bridge contact hole (second contact hole) CHB2 bored in a portion of the second planarizing film 35 that overlaps both the touch terminal area 45 and the bridge wire 46. The touch terminal area 45 and the bridge wire 46 are connected to each other through the second bridge contact hole CHB2 of the second planarizing film 35. Thus, the touch wire 30, which extends along the Y-axis direction in the display area AA, is connected via the bridge wire 46 to the touch terminal area 45, which is placed in the non-display area NAA, and is energized via the touch terminal area 45 and the bridge wire 46.

Incidentally, as shown in FIG. 4, the plurality of touch wires 30 includes a touch wire 30 connected to a touch terminal area 45 with a second trunk wire 42 interposed therebetween and a touch wire 30 connected to a touch terminal area 45 with no second trunk wire 42 interposed therebetween. In a case where a distinction between a plurality of the bridge wires 46 is made, a bridge wire 46 connected to a touch wire 30 connected to a touch terminal area 45 with a second trunk wire 42 interposed therebetween is referred to as “first bridge wire” with the suffix “α” added to its reference sign, and a bridge wire 46 connected to a touch wire 30 connected to a touch terminal area 45 with no second trunk wire 42 interposed therebetween is referred to as “second bridge wire” with the suffix “β” added to its reference sign. In a case where no distinction is made, the suffixes are not added to the reference signs. Further, in a case where a distinction is made between the plurality of touch wires 30 and touch terminal areas 45, a touch wire 30 and a touch terminal area 45 connected to a first bridge wire 46α is referred to as “first touch wire” and “first touch terminal area” with the suffix “α” added to their reference signs, and a touch wire 30 and a touch terminal area 45 connected to a second bridge wire 46β is referred to as “second touch wire” and “second touch terminal area” with the suffix “β” added to their reference signs. In a case where no distinction is made, the suffixes are not added to the reference signs.

As shown in FIGS. 4 and 8, the first bridge wire 46α is disposed to pass transversely across (straddle) the second trunk wire 42, which is interposed between the first touch wire 30α and the first touch terminal area 45α. The second planarizing film 35, which is sandwiched between the first bridge wire 46α and the second trunk wire 42, which intersect each other, allows the first bridge wire 46α and the second trunk wire 42 to avoid becoming short-circuited with each other. By thus employing a bridge structure in which the first touch wire 30α and the first touch terminal area 45α are connected to the first bridge wire 46α, the second trunk wire 42, which is composed of part of the fourth metal film can be joined directly to the heating wire 40, which is composed of part of the fourth metal film. That is, a bridge structure does not need to be employed to connect the heating wire 40 and the second trunk wire 42 to each other. If a first touch wire and a first touch terminal area are joined directly to each other without using the first bridge wire 46α, a second trunk wire is divided into two, and a bridge structure (i.e. a structure in which a bridge wire composed of part of the first transparent electrode film is connected to two divided portions of the second trunk wire) is employed to connect those divided portions to each other, there is concern that there may occur contact resistance in a place of connection of the bridge structure, whereby the place of connection becomes high in resistance to become locally markedly high in temperature. In that respect, the present embodiment, in which the heating wire 40 and the second trunk wire 42 are joined directly to each other, makes it possible to avoid the occurrence of contact resistance. This makes it hard for the heating wire 40 and the second trunk wire 42 to become locally markedly high in temperature.

Meanwhile, as shown in FIG. 4, the second bridge wire 46β does not pass transversely across the second trunk wire 42, as the second trunk wire 42 is not interposed between the second touch wire 30β and the second touch terminal area 45β. That is, although there is no problem in joining the second touch wire 30β and the second touch terminal area 45β directly to each other, the second bridge wire 46β is interposed on purpose. Thus, a connection structure between the second touch wire 30β and the second touch terminal area 45β is a bridge structure that is similar to a connection structure between the first touch wire 30α and the first touch terminal area 45α. This causes equal levels of signal blunting in a signal that is supplied to a touch electrode 29 by the first touch wire 30α and a signal that is supplied to a touch electrode 29 by the second touch wire 30β, thus bringing about improvement in display quality during the display period, during which it is hard for there to be a potential difference between the plurality of touch electrodes 29, and bringing about improvement in sensing sensitivity (position detection sensitivity) during the sensing period.

Further, as shown in FIGS. 5 and 8, the second intermediate electrode 39 and the bridge wire 46 are composed of parts of the first transparent electrode film; therefore, in manufacturing the liquid crystal panel 11, the bridge wire 46 can be provided in a step of providing the second intermediate electrode 39 by patterning the first transparent electrode film. This makes it possible to reduce the number of processes for manufacturing the liquid crystal panel 11.

Further, as shown in FIGS. 5 and 6, the heating wire 40 and the first intermediate electrode 38 are composed of parts of the fourth metal film; therefore, in manufacturing the liquid crystal panel 11, the heating wire 40 can be provided in a step of providing the first intermediate electrode 38 by patterning the fourth metal film. This makes it possible to reduce the number of processes for manufacturing the liquid crystal panel 11.

Further, as shown in FIGS. 6 and 8, the first planarizing film 34, which is located at a lower layer than the touch wire 30 and the heating wire 40, and the second planarizing film 35, which is located at a higher layer than the touch wire 30 and the heating wire 40, are greater in film thickness than other insulating films (including the second interlayer insulating film 36) composed of an inorganic material. This makes it highly certain that the touch wire 30 is kept insulated from both the touch electrode 29 and the first source wire 27α, to which the touch wire 30 is not connected, and makes it highly certain that the heating wire 40 is kept insulated from both the touch electrode 29 and the second source wire 27β. This makes it hard for the touch wire 30 to become short-circuited with the touch electrode 29 or the first source wire 27α, to which the touch wire 30 is not connected, and makes it hard for the heating wire 40 to become short-circuited with the touch electrode 29 or the second source wire 27β, thus making it possible to bring about improvement in yield.

Further, it is preferable that the fourth metal film, which constitutes the touch wire 30 and the heating wire 40, be a laminated film and contain Ti or Mo at the uppermost layer thereof. In this way, as shown in FIG. 7, the contact resistance between the touch wire 30 and the touch electrode 29, which are connected to each other through the touch contact hole CHT, becomes sufficiently as low as approximately 0.1 kΩ to 1 kΩ. This brings about improvement in display quality during the display period and brings about improvement in sensing sensitivity during the sensing period.

The first heating terminal area 43, the second heating terminal area 44, and the touch terminal area 45 may include metal films or transparent electrode films other than the fourth metal film. That is, the first heating terminal area 43, the second heating terminal area 44, and the touch terminal area 45 may be a laminated structure of the fourth metal film and other metal films or transparent electrode films.

As described above, a liquid crystal panel (display device) 11 according to the present embodiment includes an array substrate (first substrate) 21 having a display area AA where an image is displayed and a non-display area NAA where the image is not displayed, a touch wire (first wire) 30 that is placed in the display area AA of the array substrate 21, that extends along a first direction, and that is composed of part of a fourth metal film (first conducting film), a heating wire 40 that is placed in the display area AA of the array substrate 21, that extends along the first direction, and that is composed of a portion of the fourth metal film that is different from the touch wire 30, a second trunk wire (first connected portion) 42 that is placed in the non-display area NAA of the array substrate 21, that extends along a second direction intersecting the first direction, that is composed of a portion of the fourth metal film that is different from the touch wire 30 and the heating wire 40, and that is connected to the heating wire 40, a touch terminal area (second connected portion) 45 that is placed in the non-display area NAA of the array substrate 21 with the second trunk wire 42 interposed between the touch terminal area 45 and the touch wire 30 and that is composed of a portion of the fourth metal film that is different from the touch wire 30, the heating wire 40, and the second trunk wire 42, a second planarizing film (first insulating film) 35 placed at a higher layer than the fourth metal film, and a bridge wire (third connected portion) 46 that is placed in the non-display area NAA of the array substrate 21, that is composed of part of a first transparent electrode film (second conducting film) placed at a higher layer than the second planarizing film 35, and that passes transversely across the second trunk wire 42 and overlaps part of the touch wire 30 and part of the touch terminal area 45. The second planarizing film 35 is provided with a first bridge contact hole (first contact hole) CHB1 placed in such a position as to overlap both the touch wire 30 and the bridge wire 46 and a second bridge contact hole (second contact hole) CHB2 placed in such a position as to overlap both the touch terminal area 45 and the bridge wire 46.

The heating wire 40, which extends along the first direction in the display area AA, is connected to the second trunk wire 42, which extends along the second direction in the non-display area NAA, and is energized via the second trunk wire 42. When the heating wire 40 generates heat as it is energized, a member of the display area AA is heated. This makes it possible to improve the responsiveness of the liquid crystal panel 11 even in a case where the outside temperature is low. The touch wire 30, which extends along the first direction in the display area AA, is connected via the bridge wire 46 to the touch terminal area 45, which is placed in the non-display area NAA, and is energized via the touch terminal area 45 and the bridge wire 46. The second trunk wire 42, which is composed of part of the fourth metal film, is interposed between the touch wire 30 and the touch terminal area 45, which are composed of parts of the fourth metal film. On the other hand, the bridge wire 46, which is composed of part of the first transparent electrode film, passes transversely across the second trunk wire 42 and is connected to the touch wire 30 and the touch terminal area 45 through the first bridge contact hole CHB1 and the second bridge contact hole CHB2 of the second planarizing film 35. This allows the touch wire 30 and the heating wire 40 to avoid becoming short-circuited with each other. Since the heating wire 40 and the second trunk wire 42 are composed of parts of the fourth metal film and connected in such a manner as to be joined directly to each other, contact resistance is better avoided than in a case where a part composed of the first transparent electrode film is connected to the heating wire 40. This makes it hard for the heating wire 40 and the second trunk wire 42 to become locally markedly high in temperature.

Further, the liquid crystal panel 11 may further include a touch electrode (first electrode) 29 disposed to overlap at least part of the touch wire 30 and at least part of the heating wire 40, not connected to the heating wire 40, and connected to the touch wire 30. A signal that is transmitted by the touch wire 30 is supplied to the touch electrode 29. Since the touch electrode 29 is also disposed to overlap at least part of the heating wire 40, to which the touch electrode 29 is not connected, the range of formation of the touch electrode 29 can be sufficiently secured.

Further, the touch electrode 29 may be composed of a portion of the first transparent electrode film that is different from the bridge wire 46, and the second planarizing film 35 may be provided with a touch contact hole (third contact hole) CHT placed in such a position as to overlap both the touch wire 30 and the touch electrode 29. The touch wire 30 is connected to the touch electrode 29 through the touch contact hole CHT of the second planarizing film 35. The touch electrode 29 is kept insulated from the heating wire 40, which the touch electrode 29 overlaps, by the second planarizing film 35 being sandwiched between the touch electrode 29 and the heating wire 40.

Further, the liquid crystal panel 11 may further include a second interlayer insulating film (second insulating film) 36 placed at a higher layer than the first transparent electrode film, a pixel electrode 25 that is composed of part of a second transparent electrode film (third conducting film) placed at a higher layer than the second interlayer insulating film 36 and that is disposed to overlap part of the touch electrode 29, a first planarizing film (third insulating film) 34 placed at a lower layer than the fourth metal film, a source wire 27 composed of part of a third metal film (fourth conducting film) placed at a lower layer than the first planarizing film 34, a source electrode 24B joined to the source wire 27, a drain electrode 24C composed of a portion of the third metal film that is different from the source wire 27 and the source electrode 24B, a first interlayer insulating film (fourth insulating film) 33 placed at a lower layer than the third metal film, a semiconductor component 24D that is composed of part of a semiconductor film placed at a lower layer than the first interlayer insulating film 33 and that is disposed to overlap the source electrode 24B and the drain electrode 24C, a first intermediate electrode (fourth connected portion) 38 composed of a portion of the fourth metal film that is different form the touch wire 30, the heating wire 40, the second trunk wire 42, and the touch terminal area 45 and disposed to overlap the drain electrode 24C, and a second intermediate electrode (fifth connected portion) 39 composed of a portion of the first transparent electrode film that is different from the bridge wire 46 and the touch electrode 29 and disposed to overlap both the first intermediate electrode 38 and the pixel electrode 25. The touch wire 30 may be configured to transmit at least a common potential signal. At least the first interlayer insulating film 33 may be provided with a source contact hole (fourth contact hole) CHS placed in such a position as to overlap both the source electrode 24B and the semiconductor component 24D and a drain contact hole (fifth contact hole) CHD placed in such a position as to overlap both the drain electrode 24C and the semiconductor component 24D. The first planarizing film 34 may be provided with a first pixel contact hole (sixth contact hole) CHP1 placed in such a position as to overlap both the drain electrode 24C and the first intermediate electrode 38. The second planarizing film 35 may be provided with a second pixel contact hole (seventh contact hole) CHP2 placed in such a position as to overlap both the first intermediate electrode 38 and the second intermediate electrode 39. The second interlayer insulating film 36 may be provided with a third pixel contact hole (eighth contact hole) CHP3 placed in such a position as to overlap both the second intermediate electrode 39 and the pixel electrode 25. When a channel region is formed in the semiconductor component 24D, an image signal that is supplied from the source wire 27 to the source electrode 24B is transmitted to the drain electrode 24C via the channel region. Since the pixel electrode 25 is connected to the drain electrode 24C via the first intermediate electrode 38 and the second intermediate electrode 39, the pixel electrode 25 is charged to a potential pertaining to the image signal transmitted to the drain electrode 24C. When the common potential signal is supplied to the touch electrode 29 by the touch wire 30, an electric field based on a potential difference between the touch electrode 29 and the pixel electrode 25 is generated between the touch electrode 29 and the pixel electrode 25. In manufacturing the liquid crystal panel 11, the heating wire 40 can be provided in a step of providing the first intermediate electrode 38 by patterning the fourth metal film, as the heating wire 40 and the first intermediate electrode 38 are composed of parts of the fourth metal film.

Further, the source wire 27 may extend along the first direction and include a plurality of the source wires 27 placed at spacings in the second direction. The touch wire 30 may be disposed to overlap a first source wire 27α included in the plurality of source wires 27. The heating wire 40 may be disposed to overlap a second source wire 27β included in the plurality of source wires 27. Since the touch wire 30 and the first source wire 27α run parallel to each other and overlap each other and the heating wire 40 and the second source wire 27β run parallel to each other and overlap each other, improvement in aperture ratio can be brought about.

Further, the second planarizing film 35 and the first planarizing film 34 may be greater in film thickness than the second interlayer insulating film 36. Since the second planarizing film 35 is greater in film thickness than the second interlayer insulating film 36, it is highly certain that the touch wire 30 and the touch electrode 29 are kept insulated from each other and the heating wire 40 and the touch electrode 29 are kept insulated from each other. Since the first planarizing film 34 is greater in film thickness than the second interlayer insulating film 36, it is highly certain that the touch wire 30 and the first source wire 27α are kept insulated from each other and the heating wire 40 and the second source wire 27β are kept insulated from each other. This makes it hard for the touch wire 30 to become short-circuited with the touch electrode 29 or the first source wire 27α and makes it hard for the heating wire 40 to become short-circuited with the touch electrode 29 or the second source wire 27β, thus making it possible to bring about improvement in yield.

Further, the touch wire 30 may transmit a common potential signal and a position detection signal in a time-division manner. At a timing when the common potential signal is supplied by the touch wire 30, the touch electrode 29 fulfills a display function of generating an electric field between the touch electrode 29 and the pixel electrode 25, and at a timing when the position detection signal is supplied by the touch wire 30, the touch electrode 29 fulfills a position detection function of forming a capacitance between the touch electrode 29 and the position input body. Since the range of formation of the touch electrode 29 is so extended as to overlap at least part of the heating wire 40, to which the touch electrode 29 is not connected, the touch electrode 29 brings about improvement in position detection sensitivity.

Further, the liquid crystal panel 11 may further include a counter substrate (second substrate) 20 placed opposite the array substrate 21 at a distance from the array substrate 20 and a liquid crystal layer 22 sandwiched between the array substrate 21 and the counter substrate 20. The liquid crystal layer 22, which is sandwiched between the array substrate 21 and the counter substrate 20 improves in response speed by being heated by the heating wire 40. The improvement in the response speed of the liquid crystal layer 22 can bring about improvement in display quality.

### Embodiment 2

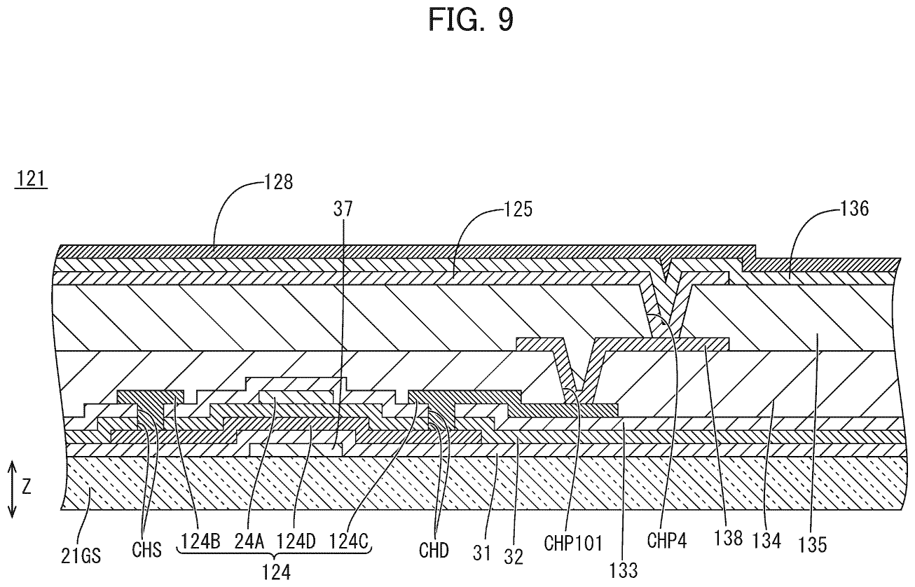

Embodiment 2 is described with reference to FIGS. 9 to 11. Embodiment 2 illustrates a case where the positional relationship between a pixel electrode 125 and a common electrode 128 (touch electrodes 129) is reversed. A repeated description of structures, workings, and effects which are similar to those of Embodiment 1 is omitted.

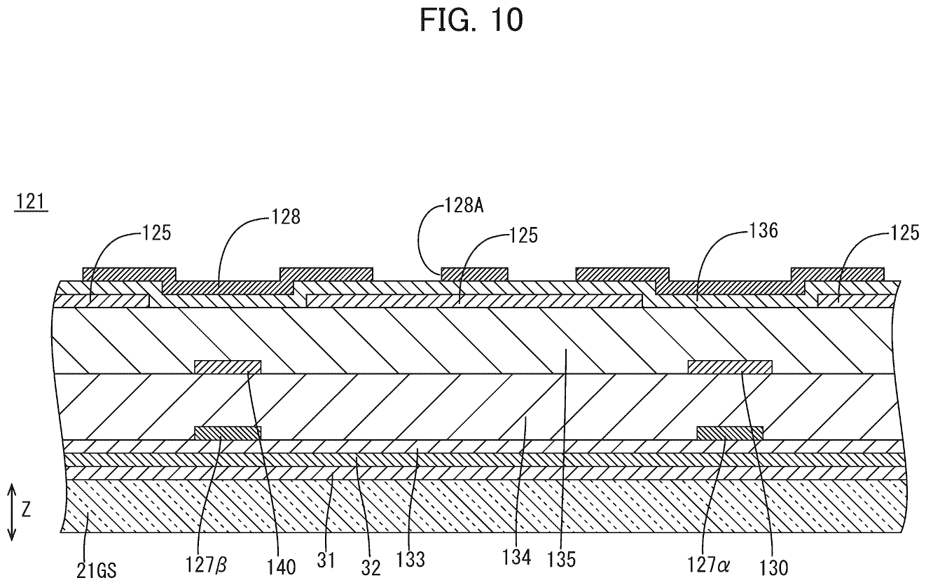

In the array substrate 121 according to the present embodiment, as shown in FIGS. 9 and 10, the pixel electrode 125 is composed of part of the first transparent electrode film, and the common electrode 128 (touch electrode 129) is composed of part of a second transparent electrode film. The common electrode 128 has a plurality of slits 128A bored in portions of the common electrode 128 that overlap the pixel electrode 125. Due to such a configuration, the TFT 124 includes a first intermediate electrode 138 located in between the drain electrode 124C, which is composed of part of the third metal film, and the pixel electrode 125, which is composed of part of the first transparent electrode film, but does not have the second intermediate electrode 39 (see FIG. 5) described in Embodiment 1. The first intermediate electrode 138, which is composed of part of the fourth metal film, is connected to the drain electrode 124C, which is composed of part of the third metal film, through a first pixel contact hole CHP101 provided in the first planarizing film 134. Part of the pixel electrode 125 is disposed at a higher layer than part of the first intermediate electrode 138 (i.e. a portion of the first intermediate electrode 138 that does not overlap the drain electrode 124C) to overlap the part of the first intermediate electrode 138 via the second planarizing film 135. The second planarizing film 135 has a fourth pixel contact hole (eleventh contact hole) CHP4 bored in a portion of the second planarizing film 135 that overlaps both the first intermediate electrode 138 and the pixel electrode 125. The pixel electrode 125, which is composed of part of the first transparent electrode film, is connected to the first intermediate electrode 138, which is composed of the fourth metal film, through the fourth pixel contact hole CHP4 of the second planarizing film 135.

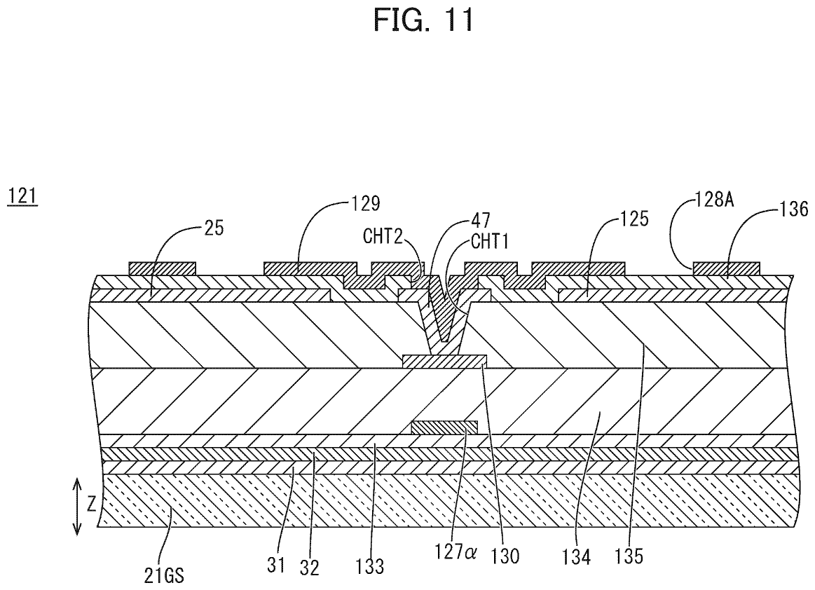

As shown in FIG. 11, the array substrate 121 according to the present embodiment is provided with a third intermediate electrode (sixth connected portion) 47 for connecting the touch electrode 129, which is composed of part of the second transparent electrode film, and the touch wire 130, which is composed of part of the fourth metal film. The third intermediate electrode 47 is composed of a portion of the first transparent electrode film that is different from the pixel electrode 125 and the bridge wire 46 (see FIG. 8). The third intermediate electrode 47 is disposed at a higher layer than part of the touch wire 130 to overlap the part of the touch wire 130 via the second planarizing film 135. The third intermediate electrode 47 is disposed at a lower layer than part of the touch electrode 129 to overlap the part of the touch electrode 129 via the second interlayer insulating film 136. The second planarizing film 135, which is sandwiched between the touch wire 130 and the third intermediate electrode 47, has a first touch contact hole (ninth contact hole) CHT1 bored in a portion of the second planarizing film 135 that overlaps both the touch wire 130 and the third intermediate electrode 47. The touch wire 130 and the third intermediate electrode 47 are connected to each other via the first touch contact hole CHT1 of the second planarizing film 135. The second interlayer insulating film 136, which is sandwiched between the third intermediate electrode 47 and the touch electrode 129, has a second touch contact hole (tenth contact hole) CHT2 bored in a portion of the second interlayer insulating film 136 that overlaps both the third intermediate electrode 47 and the touch electrode 129. The third intermediate electrode 47 and the touch electrode 129 are connected to each other through the second touch contact hole CHT2 of the second interlayer insulating film 136. Thus, the touch wire 130 is connected to the touch electrode 129 via the third intermediate electrode 47.

As described above, the liquid crystal panel 11 according to the present embodiment may further include a second interlayer insulating film 136 placed at a higher layer than the first transparent electrode film and a third intermediate electrode (sixth connected portion) 47 composed of a portion of the first transparent electrode film that is different from the bridge wire 46 and disposed to overlap part of the touch wire 130 and part of the touch electrode 129. The touch electrode 129 may be composed of part of a second transparent electrode film placed at a higher layer than the second interlayer insulating film 136. The second planarizing film 135 may be provided with a first touch contact hole (ninth contact hole) CHT1 placed in such a position as to overlap both the touch wire 130 and the third intermediate electrode 47. The second interlayer insulating film 136 may be provided with a second touch contact hole (tenth contact hole) CHT2 placed in such a position as to overlap both the third intermediate electrode 47 and the touch electrode 129. The touch wire 130 is connected to the third intermediate electrode 47 through the first touch contact hole CHT1 of the second planarizing film 135. The third intermediate electrode 47 is connected to the touch electrode 129 through the second touch contact hole CHT2 of the second interlayer insulating film 136. Thus, the touch wire 130 is connected to the touch electrode 129 via the third intermediate electrode 47. The touch electrode 129 is kept insulated from the heating wire 140, which the touch electrode 129 overlaps, by the second planarizing film 135 and the second interlayer insulating film 136 being sandwiched between the touch electrode 129 and the heating wire 140.

Further, the liquid crystal panel 11 may further include a pixel electrode 125 composed of a portion of the first transparent electrode film that is different from the bridge wire 46 and the third intermediate electrode 47, a first planarizing film 134 disposed to overlap the pixel electrode 125 and placed at a lower layer than the fourth metal film, a source wire 127 composed of part of a third metal film placed at a lower layer than the first planarizing film 134, a source electrode 124B joined to the source wire 127, a drain electrode 124C composed of a portion of the third metal film that is different from the source wire 127 and the source electrode 124B, a third interlayer insulating film 133 placed at a lower layer than the third metal film, a semiconductor component 124D that is composed of part of a semiconductor film placed at a lower layer than the first interlayer insulating film 133 and that is disposed to overlap the source electrode 124B and the drain electrode 124C, and a first intermediate electrode 138 composed of a portion of the fourth metal film that is different from the touch wire 130, the heating wire 140, the second trunk wire 142, and the touch terminal area 145 and disposed to overlap the drain electrode 124C. The touch wire 130 may be configured to transmit at least a common potential signal. The first interlayer insulating film 133 may be provided with a source contact hole CHS placed in such a position as to overlap both the source electrode 124B and the semiconductor component 124D and a drain contact hole CHD placed in such a position as to overlap both the drain electrode 124C and the semiconductor component 124D. The first planarizing film 134 may be provided with a first pixel contact hole CHP101 placed in such a position as to overlap both the drain electrode 124C and the first intermediate electrode 138. The second planarizing film 135 may be provided with a fourth pixel contact hole (eleventh contact hole) CHP4 placed in such a position as to overlap both the first intermediate electrode 138 and the pixel electrode 125. When a channel region is formed in the semiconductor component 124D, an image signal that is supplied from the source wire 127 to the source electrode 124B is transmitted to the drain electrode 124C via the channel region. Since the pixel electrode 125 is connected to the drain electrode 124C via the first intermediate electrode 138, the pixel electrode 125 is charged to a potential pertaining to the image signal transmitted to the drain electrode 124C. When the common potential signal is supplied to the touch electrode 129 by the touch wire 130, an electric field based on a potential difference between the touch electrode 129 and the pixel electrode 125 is generated between the touch electrode 129 and the pixel electrode 125. In manufacturing the liquid crystal panel 11, the heating wire 140 can be provided in a step of providing the first intermediate electrode 138 by patterning the fourth metal film, as the heating wire 140 and the first intermediate electrode 138 are composed of parts of the fourth metal film.

Further, the source wire 127 may extend along the first direction and include a plurality of the source wires 127 placed at spacings in the second direction. The touch wire 130 may be disposed to overlap a first source wire 127α included in the plurality of source wires 127. The heating wire 140 may be disposed to overlap a second source wire 127β included in the plurality of source wires 127. Since the touch wire 130 and the first source wire 127α run parallel to each other and overlap each other and the heating wire 140 and the second source wire 127β run parallel to each other and overlap each other, improvement in aperture ratio can be brought about.

Further, the second planarizing film 135 and the first planarizing film 134 may be greater in film thickness than the second interlayer insulating film 136. Since the second planarizing film 135 is greater in film thickness than the second interlayer insulating film 136, it is highly certain that the touch wire 130 and the pixel electrode 125 are kept insulated from each other and the heating wire 140 and the pixel electrode 125 are kept insulated from each other. Since the first planarizing film 134 is greater in film thickness than the second interlayer insulating film 136, it is highly certain that the touch wire 130 and the first source wire 127α are kept insulated from each other and the heating wire 140 and the second source wire 127β are kept insulated from each other. This makes it hard for the touch wire 130 to become short-circuited with the pixel electrode 125 or the first source wire 127α and makes it hard for the heating wire 140 to become short-circuited with the pixel electrode 125 or the second source wire 127β, thus making it possible to bring about improvement in yield.

### Other Embodiments

The present disclosure is not limited to the embodiments described with reference to the foregoing description and drawings. For example, embodiments such as those listed below are encompassed in the technical scope.
(1) Instead of being placed in the exposed portions 21A of the array substrates 21 and 121, the second trunk wires 42 and 142 may be placed in portions of the array substrates 21 and 121 that overlap the counter substrate 20.
(2) The lengths of the second trunk wires 42 and 142 and the numbers of second trunk wires 42 and 142 that are provided are subject to appropriate change other than those illustrated. As the second trunk wires 42 and 142 become longer in the X-axis direction, the numbers of second trunk wires 42 and 142 that are provided become smaller. At the same time, the number of first bridge wires 46α that intersect the second trunk wires 42 and 142 tends to increase, and the number of second bridge wires 46β that do not intersect the second trunk wires 42 and 142 tends to decrease.
(3) In (2) above, the second trunk wires 42 and 142 may have lengths along substantially the entire length of the display area AA in the X-axis direction. In this case, all bridge wires 46 intersect the second trunk wires 42 and 142. That is, all bridge wires 46 serve as first bridge wires 46α.
(4) It is also possible to omit the second bridge wire 46 β and join the second touch wire 30β and the second touch terminal area 45β directly to each other.
(5) The touch terminal areas 45 and 145 may be placed with position gaps with respect to the touch wires 30 and 130, to which the touch terminal areas 45 and 145 are connected, in the X-axis direction. In that case, at least some of the bridge wires 46 need only be configured to extend along in an oblique direction inclined with respect to both the X-axis direction and the Y-axis direction.
(6) The negative electrode of the power supply IC 16A of the control substrate 16 may be connected to the first heating terminal area 43 via the flexible substrate 14, and the positive electrode of the power supply IC 16A of the control substrate 16 may be connected to the second heating terminal area 44 via the flexible substrate 14.
(7) The first planarizing films 34 and 134, which are made of an organic material, may be replaced by insulating films made of an inorganic material.
(8) The second planarizing films 35 and 135, which are made of an organic material, may be replaced by insulating films made of an inorganic material.
(9) The TFTs 24 and 124 may have a bottom-gate structure, i.e. a structure in which the gate electrode 24A is disposed at a lower layer than the semiconductor component to overlap the semiconductor component.
(10) It is also possible to omit the light shield 37. In that case, the first metal film may be removed, which gives three metal films.
(11) The driver 15 may be mounted on the exposed portion 21A of each of the array substrates 21 and 121 by COG (Chip on Glass). In that case, the touch terminal areas 45 and 145 and display terminal areas may be placed in such positions as to overlap the driver 15 and connected to terminal areas of the driver 15 via an anisotropic conductive film.
(12) The touch panel controller 16C may be provided on the flexible substrate 14 or other substrates.
(13) The liquid crystal panel 11 does not need to have the touch panel function. In the liquid crystal panel 11 that does not have the touch panel function, the common electrodes 28 and 128 have an undivided structure. The common electrodes 28 and 128 that have an undivided structure may have high in-plane resistance distributions due to the screen size or other attributes of the liquid crystal panel 11. In that case, the array substrates 21 and 121 need only be provided with common wires (first wires) using the fourth metal film, which is lower in sheet resistance than the first transparent electrode film, which constitutes the common electrodes (first electrodes) 28 and 128. The common wires composed of part of the fourth metal film are substantially the same in configuration as the touch wires 30 and 130 described above, and are disposed to overlap the source wires 27 and 127 (first source wires 27α and 127α), which are composed of the third metal film, in the display area AA. When applied to the configuration described in Embodiment 1, the common wire is connected to the common electrode 28, which is composed of part of the first transparent electrode film, through a contact hole bored in the second planarizing film 35. When applied to the configuration described in Embodiment 2, the common wire is connected through a contact hole bored in the second planarizing film 135 to an intermediate electrode composed of part of the first transparent electrode film, and the intermediate electrode is connected to the common electrode 128 through a contact hole bored in the second interlayer insulating film 136. In either case, the third metal film, which constitutes the common wires, is lower in sheet resistance than the first transparent electrode film, which constitutes the common electrodes 28 and 128, and can therefore reduce the in-plane resistance distributions in the common electrodes 28 and 128, thereby making it possible to stably keep the common electrodes 28 and 128 at a common potential.
(14) It is also possible to omit the circuit unit 12. In that case, gate drivers having functions similar to those of the circuit unit 12 may be attached to the array substrates 21 and 121. Further, it is also possible to provide the circuit unit 12 on only one side of each of the array substrates 21 and 121.
(15) The semiconductor components 24D and 124D may be constituted by semiconductor films made of a material such as amorphous silicon or an oxide semiconductor material.
(16) The planar shape of the liquid crystal panel 11 may be a vertically long rectangle, a regular square, a circle, a semicircle, an oval, an ellipse, a trapezoid, or other shapes.
(17) The display mode of the liquid crystal panel 11 may be a VA mode, an IPS mode, or other modes other than the FFS mode.
(18) The liquid crystal panel 11 may be of a reflective type or a semi-transmissive type instead of being of a transmissive type. In a case where the liquid crystal panel 11 is of a reflective type, the backlight device can be omitted.
(19) The liquid crystal panel 11 may be replaced by another display panel (such as an organic EL display panel).

The present disclosure contains subject matter related to that disclosed in Japanese Priority Patent Application JP 2024-195107 filed in the Japan Patent Office on Nov. 7, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first substrate having a display area where an image is displayed and a non-display area where the image is not displayed;
a first wire that is placed in the display area of the first substrate, that extends along a first direction, and that is composed of part of a first conducting film;
a heating wire that is placed in the display area of the first substrate, that extends along the first direction, and that is composed of a portion of the first conducting film that is different from the first wire;
a first connected portion that is placed in the non-display area of the first substrate, that extends along a second direction intersecting the first direction, that is composed of a portion of the first conducting film that is different from the first wire and the heating wire, and that is connected to the heating wire;
a second connected portion that is placed in the non-display area of the first substrate with the first connected portion interposed between the second connected portion and the first wire and that is composed of a portion of the first conducting film that is different from the first wire, the heating wire, and the first connected portion;
a first insulating film placed at a higher layer than the first conducting film; and
a third connected portion that is placed in the non-display area of the first substrate, that is composed of part of a second conducting film placed at a higher layer than the first insulating film, and that passes transversely across the first connected portion and overlaps part of the first wire and part of the second connected portion,
wherein the first insulating film is provided with a first contact hole placed in such a position as to overlap both the first wire and the third connected portion and a second contact hole placed in such a position as to overlap both the second connected portion and the third connected portion.

2. The display device according to claim 1, further comprising a first electrode disposed to overlap at least part of the first wire and at least part of the heating wire, not connected to the heating wire, and connected to the first wire.

3. The display device according to claim 2, wherein
the first electrode is composed of a portion of the second conducting film that is different from the third connected portion, and
the first insulating film is provided with a third contact hole placed in such a position as to overlap both the first wire and the first electrode.

4. The display device according to claim 3, further comprising:
a second insulating film placed at a higher layer than the second conducting film;
a pixel electrode that is composed of part of a third conducting film placed at a higher layer than the second insulating film and that is disposed to overlap part of the first electrode;
a third insulating film placed at a lower layer than the first conducting film;
a source wire composed of part of a fourth conducting film placed at a lower layer than the third insulating film;
a source electrode joined to the source wire;
a drain electrode composed of a portion of the fourth conducting film that is different from the source wire and the source electrode;
a fourth insulating film placed at a lower layer than the fourth conducting film;
a semiconductor component that is composed of part of a semiconductor film placed at a lower layer than the fourth insulating film and that is disposed to overlap the source electrode and the drain electrode;
a fourth connected portion composed of a portion of the first conducting film that is different form the first wire, the heating wire, the first connected portion, and the second connected portion and disposed to overlap the drain electrode; and
a fifth connected portion composed of a portion of the second conducting film that is different from the third connected portion and the first electrode and disposed to overlap both the fourth connected portion and the pixel electrode,
wherein
the first wire is configured to transmit at least a common potential signal,
the fourth insulating film is provided with a fourth contact hole placed in such a position as to overlap both the source electrode and the semiconductor component and a fifth contact hole placed in such a position as to overlap both the drain electrode and the semiconductor component,
the third insulating film is provided with a sixth contact hole placed in such a position as to overlap both the drain electrode and the fourth connected portion,
the first insulating film is provided with a seventh contact hole placed in such a position as to overlap both the fourth connected portion and the fifth connected portion, and
the second insulating film is provided with an eighth contact hole placed in such a position as to overlap both the fifth connected portion and the pixel electrode.

5. The display device according to claim 4, wherein
the source wire extends along the first direction and comprises a plurality of the source wires placed at spacings in the second direction,
the first wire is disposed to overlap a first source wire included in the plurality of source wires, and
the heating wire is disposed to overlap a second source wire included in the plurality of source wires.

6. The display device according to claim 5, wherein the first insulating film and the third insulating film are greater in film thickness than the second insulating film.

7. The display device according to claim 2, further comprising:
a second insulating film placed at a higher layer than the second conducting film; and
a sixth connected portion composed of a portion of the second conducting film that is different from the third connected portion and disposed to overlap part of the first wire and part of the first electrode,
wherein
the first electrode is composed of part of a third conducting film placed at a higher layer than the second insulating film,
the first insulating film is provided with a ninth contact hole placed in such a position as to overlap both the first wire and the sixth connected portion, and
the second insulating film is provided with a tenth contact hole placed in such a position as to overlap both the sixth connected portion and the first electrode.

8. The display device according to claim 7, further comprising:
a pixel electrode composed of a portion of the second conducting film that is different from the third connected portion and the sixth connected portion;
a third insulating film disposed to overlap the pixel electrode and placed at a lower layer than the first conducting film;
a source wire composed of part of a fourth conducting film placed at a lower layer than the third insulating film;
a source electrode joined to the source wire;
a drain electrode composed of a portion of the fourth conducting film that is different from the source wire and the source electrode;
a fourth insulating film placed at a lower layer than the fourth conducting film;
a semiconductor component that is composed of part of a semiconductor film placed at a lower layer than the fourth insulating film and that is disposed to overlap the source electrode and the drain electrode; and
a fourth connected portion composed of a portion of the first conducting film that is different from the first wire, the heating wire, the first connected portion, and the second connected portion and disposed to overlap the drain electrode,
wherein
the first wire is configured to transmit at least a common potential signal,
the fourth insulating film is provided with a fourth contact hole placed in such a position as to overlap both the source electrode and the semiconductor component and a fifth contact hole placed in such a position as to overlap both the drain electrode and the semiconductor component,
the third insulating film is provided with a sixth contact hole placed in such a position as to overlap both the drain electrode and the fourth connected portion, and
the first insulating film is provided with an eleventh contact hole placed in such a position as to overlap both the fourth connected portion and the pixel electrode.

9. The display device according to claim 8, wherein
the source wire extends along the first direction and comprises a plurality of the source wires placed at spacings in the second direction,
the first wire is disposed to overlap a first source wire included in the plurality of source wires, and
the heating wire is disposed to overlap a second source wire included in the plurality of source wires.

10. The display device according to claim 9, wherein the first insulating film and the third insulating film are greater in film thickness than the second insulating film.

11. The display device according to claim 1, wherein the first wire transmits a common potential signal and a position detection signal in a time-division manner.

12. The display device according to claim 1, further comprising:
a second substrate placed opposite the first substrate at a distance from the first substrate; and
a liquid crystal layer sandwiched between the first substrate and the second substrate.
